(19) United States
(12) Patent Application Publication
(10) Pub. No.: US 2019/0133119 A1
(43) Pub. Date: May 9, 2019

(54) PLASTISOL-COATED AGROCHEMICAL FORMULATIONS AND METHODS OF USE

(71) Applicant: CROP ENHANCEMENT, INC., San Jose, CA (US)

(72) Inventors: Robert P. Mahoney, Newbury, MA (US); Matthew A. Bosley, Watertown, MA (US); David S. Soane, Palm Beach, FL (US)

(21) Appl. No.: 16/132,752

(22) Filed: Sep. 17, 2018

Related U.S. Application Data
(63) Continuation of application No. PCT/US17/22676, filed on Mar. 16, 2017.
(60) Provisional application No. 62/309,563, filed on Mar. 17, 2016.

(51) Int. Cl. A01N 25/26; C05G 3/00; C05C 9/00; C05C 1/00; C05D 1/00; C09D 133/12; C09D 101/10; C09D 101/14; C09D 7/63

(52) U.S. Cl. CPC A01N 25/26; C05G 3/0029; C05G 3/0035; C05C 9/00; C09D 7/63; C05D 1/00; C09D 133/12; C09D 101/10; C09D 101/14; C05C 1/00

(57) ABSTRACT

The invention is directed to plastisol coating formulations for agricultural uses. The plastisol-coated agrochemicals comprise a coating formed from a plastisol formulation, wherein the plastisol formulation comprises a suspension of polymer particles in a liquid plasticizer, and a solid agrochemical, wherein the coating is applied to the solid agrochemical and cured to form a film thereupon.

### RELATED APPLICATIONS

This application is a continuation of International Application No. PCT/US17/22676, which designated the United States and was filed on Mar. 16, 2017, published in English, which claims the benefit of U.S. Provisional Application No. 62/309,563 filed Mar. 17, 2016. The entire contents of the above-referenced applications are incorporated by reference herein.

### FIELD OF THE APPLICATION

This application relates to plastisol coating formulations for agricultural uses.

### BACKGROUND

Various agricultural chemicals (“agrochemicals”), such as active ingredients (AIs) useful for agricultural purposes, for example, nutrients, pesticides, herbicides, insecticides, fungicides, plant growth regulators, plant hormones, pheromones, and fertilizers, exhibit a wide range of water solubilities, from insoluble/sparingly soluble, to moderately soluble, to highly soluble. Moderately soluble and highly soluble AIs are prone to loss due to erosion and leaching from treated soils and plants. Similarly, certain nutrients like water-soluble fertilizers that are applied to fields can suffer run-off or loss caused by rapid watering, rain, or other water exposures.

As an example, fertilizers typically contain some amount of water-soluble plant nutrients, and they are delivered in proximity to the plants. Fertilizers can contain water-soluble compounds such as nitrogen, phosphorus, and potassium compounds alone or in combination; additionally, they can be combined with other elements (e.g., calcium, boron, zinc, chlorine, etc.,) or other inert or water-insoluble materials. As examples, fertilizers can contain compounds such as urea, ammonium nitrate, potassium chloride, and the like. In addition, fertilizers can be combined with other active ingredients or agrochemicals such as herbicides, pesticides, fungicides, trace elements, sulfur, iron, etc. Plant fertilizers can be produced in solid form, having different particle sizes and types, such as granules, pellets, dusts, pills, and the like.

The water-soluble nature of these solid fertilizers allows the delivery of the nutrients to the plants, e.g., by release into the soil and thence into the root system. However, the solubility of these fertilizers can lead to a nutrient release that is too rapid for the plant system. For example, if the nutrients are released too quickly, they can cause toxicity to the plants themselves. In addition, the rapid release can result in leaching of nutrients away from the plant system, especially with irrigation or rainfall. As an additional drawback, solid fertilizers have a tendency to cake when stored and to form dust when handled. There remains a need in the art, therefore, to provide a controlled release of the active ingredients, e.g., the nutrients, contained in a solid agrochemical such as a fertilizer so that the appropriate dose of the active ingredient is delivered to the plant system throughout the desired segment of the growing cycle. There remains a further need in the art to improve storage and handling for these solid materials.

Additionally, agricultural chemicals such as active ingredients useful for agricultural purposes, for example, nutrients, pesticides, herbicides, insecticides, fungicides, plant growth regulators, plant hormones, pheromones, and fertilizers, can cause environmental damage, health effects, safety and handling problems; as well, they can be expensive. As an example, many of the coatings used to make encapsulated agrochemicals are made with hazardous isocyanate reagents, and there remains a need for safer alternatives to isocyanate based coating processes.

Desirably, coating formulations could meet these additional needs, to yield a platform technology for treating AIs that allows for 1) prolonged retention of AIs, 2) reliable, sustainable and tunable release kinetics, 3) minimum use of formulation materials, preferably at low cost with safe reagents, and 4) flexible applicability to a large array of agrochemicals, such as AIs, for example nutrients, pesticides, herbicides, insecticides, fungicides, plant growth regulators, plant hormones, pheromones, and fertilizers.

### SUMMARY

Disclosed herein, in embodiments, are plastisol-coated agrochemicals, comprising a coating formed from a plastisol formulation, wherein the plastisol formulation comprises a suspension of polymer particles in a liquid plasticizer, and a solid agrochemical, wherein the coating is applied to the solid agrochemical and cured to form a film thereupon. In embodiments, the polymer particles are solid polymeric resin particles. In embodiments, the solid polymeric resin particles are selected from the group consisting of PVC, PVC copolymers, PMMA, PMMA copolymers, cellulose ethers, and cellulose esters. In additional embodiments, the solid polymeric resin particles are selected from the group consisting of PVC, PVC copolymers, PMMA, PMMA copolymers, and cellulose esters. In embodiments, the solid polymeric resin particles comprise PMMA. In embodiments, the solid polymeric resin particles are biodegradable. The solid polymeric resin particles can be selected from the group consisting of cellulose esters, cellulose ethers, cellulose acetates, cellulose acetate butyrates, cellulose acetate propionates, cellulose acetate phthalates, cellulose triacetates, ethylcellulose, methylcellulose, starch esters, and modified starches. In embodiments, the solid polymeric resin particles comprise a crosslinker. In embodiments, the plasticizer is selected from the group consisting of benzoate esters, dibenzoate esters, terephthalate esters, cyclohexanedicarboxylate esters, citrate esters, phthalate esters, and cellulose esters. In embodiments, the plasticizer is a monoester or diester of a dicarboxylic acid selected from the group consisting of malonates, succinates, glutarates, adipates, pimelates, sebacates, azelates, dibenzoates, citrates, trimellitates, cyclohexanoates, phthalates, and terephthalates. In embodiments, the plasticizer is a polyester formed from a diacid, and a diol or polyol. In embodiments, the plasticizer is biodegradable. In embodiments, the agrochemical comprises an active ingredient selected from the group consisting of example nutrients, pesticides, herbicides, insecticides, fungicides, plant growth regulators, plant hormones, pheromones, and fertilizers. The fertilizer can be urea, ammonium nitrate, or potassium chloride. In embodiments, the active ingredient is moderately water soluble or highly water soluble. Further disclosed herein, in embodiments, are methods of affecting the well-being of an agricultural target, comprising providing a plastisol-coated agrochemical as described above, and applying an effective amount of the plastisol-coated agrochemical upon the agricultural target, wherein the effective amount affects the well-being of the agricultural target. In embodiments, the plastisol-coated agrochemical used for these methods comprises a coating comprising a PMMA or a PMMA copolymer, and further comprises an agrochemical comprising urea.

### DETAILED DESCRIPTION

The present disclosure relates to plastisol coating formulations suitable for agricultural uses, and to plastisol-coated agrochemical formulations suitable for agricultural uses. As used herein, the term “plastisol” refers to a suspension of polymer particles in a liquid plasticizer where the polymer dissolves in the plasticizer (a state called “fusion”) when the mixture is heated above a certain temperature, known as its fusion temperature. After fusion and when the polymer/plasticizer solution is cooled, it solidifies and results in a pliable plastic film or solid. As a pliable plastic film, the plastisol can be used to coat agrochemicals or other agricultural substrates. As used herein, the term “coating” refers to any coating or encapsulation that is applied to particulate matter such as a solid agrochemical, whether each particle is coated individually or whether clusters of particles are coated in aggregation. In making a plastisol-coated agrochemical, the plastisol preferably has a fusion temperature below the melting point of the agrochemical, although it can be envisioned, in embodiments, that a plastisol-coated agrochemical can form if the agrochemical melts when contacted by the plastisol formulation.

The most widely used plastisol in commercial applications is polyvinylchloride (PVC) blended with a plasticizer, and these blends generally have fusion temperatures of 140-180° C. The PVC-based plastisols are not suitable for use with certain agrochemicals, however, because their fusion temperatures are higher than the melting point of the agrochemical itself. For example, urea, a high-volume solid fertilizer in pellet form, has a melting point of 133° C., so that urea pellets would melt at the typical PVC plastisol fusion temperature. However, there are other types of plastisol formulations having fusion temperatures below the melting point of urea that would be suitable for use with this agrochemical. Similarly, for other agrochemicals, plastisol formulations can be created having fusion temperatures below the melting point of the agrochemical substrate in question. In embodiments, a plastisol coating formulation can be made using a crosslinker that is reactive with the resin, the plasticizer, or the agrochemical. The coating formulation made with a crosslinker can have improved curing rate or improved physical properties such as hardness, solubility, release profile, or durability, compared with the coating formulations made without a crosslinker.

1. Plastisol Formulations

In embodiments, a plastisol formulation suitable for coating agrochemicals comprises a combination of one or more liquid plasticizers and a solid polymeric resin, with the plasticizers selected so that when heated beyond a certain temperature will irreversibly cause the resin and plasticizers to become mutually soluble in each other and cure into an effective solid barrier once the temperature is reduced below that temperature. In one embodiment, the solid polymeric resin can comprise polymethylmethacrylate (PMMA) resin. In embodiments where PMMA resin is used as the polymeric resin, plasticizers such as benzoate esters, cyclohexanedicarboxylate esters, phthalate esters, citrate esters, and terephthalate esters, or a polyester formed from the same diacids can be used. The polymeric resin and the plasticizer(s) can then be combined and heated to their fusion temperature to form the plastisol. With a fusion temperature for these plastisols ranging from 80°-120° C., these formulations are suitable for coating urea and other agrochemicals having melting points above the specific plastisol formulation's fusion temperature. In embodiments, solvents such as toluene and xylene can be used to reduce the viscosity of the plastisol formulation during the coating process.

The polymer component of the plastisol can be a single polymer or a blend of polymers. The polymer component can be a biodegradable material or a recycled material. Examples of suitable plastisol polymer components for agricultural uses include PVC, PVC copolymers, PMMA copolymers PMMA, cellulose ethers, and cellulose esters. In embodiments, the plastisol polymer component can be in the form of a powder with a particle size of <1 mm. In embodiments, the plastisol polymer component can have a particle size of <100 μm, or even <10 μm. The polymer can be a methyl methacrylate copolymer such as Dianal LP-3202, Dianal LP-3207, Dianal LP-3109, and Dianal LP-3209 manufactured by Mitsubishi Rayon.

In embodiments, the plasticizer component of the plastisol coating can be a benzoate ester, a dibenzoates ester, a terephthalate ester, a cyclohexanedicarboxylate ester, a citrate ester, a phthalate ester, or a cellulose ester. In embodiments, the plasticizer component of the plastisol coating can be a monoester or diester of a dicarboxylic acid, such as malonates, succinates, glutarates, adipates, pimelates, sebacates, azelates, dibenzoates, citrates, trimellitates, cyclohexanoates, phthalates, and terephthalates. In other embodiments, the plasticizer component can be a polyester formed from a diacid and a diol or polyol. In embodiments, the plasticizer can be a biodegradable material such as a citrate or a diester of an alkyl diacid. Examples of plasticizers include Benzoflex 131 and Benzoflex 181 (benzoates from Eastman Chemical), dioctyladipate, and acetyltributylcitrate (ATBC).

Polymer resins suitable for making plastisols are widely available and non-hazardous, such as PVC, PMMA, starches, cellulose ethers, and cellulose esters. The agrochemicals coated with plastisols can offer reduced dusting and reduced exposure of workers to the agrochemicals. Use of the plastisol coating as described herein does not require the use of hazardous isocyanate reagents.

Plastisol coatings for agricultural uses can be made biodegradable by using degradable plasticizers and/or polymers. For example, many suitable plasticizers are esters which have a cleavable linkage to enable breakdown. The polymer component can comprise a biodegradable polymer such as a cellulose ester, cellulose ether, cellulose acetate, cellulose acetate butyrate, cellulose acetate propionate, cellulose acetate phthalate, cellulose triacetate, ethylcellulose, methylcellulose, starch esters, and modified starches.

In embodiments, the plastisol-coated agrochemical formulations can include a crosslinker. The crosslinker can be a chemical reagent that is reactive with the polymer resin, the plasticizer, or the agrochemical. Including a crosslinker in the plastisol-coated agrochemical formulation can improve the properties of the formulation, such as the hardness, solubility, release profile, or durability, compared with the coating formulations made without a crosslinker. Exemplary crosslinkers include monofunctional, bifunctional, trifunctional, or polyfunctional types of crosslinker reagents. Crosslinkers that can be used in the formulations of the invention include diglycidyl ethers, dialdehydes, diepoxides, maleimides, formaldehyde, divinyl reagents, methylenebisacrylamide, polyethylene glycol diglycidyl ether, epichlorohydrin, maleic anhydride, glyoxal, glutaraldehyde, toluene diisocyanate, and methylene diphenyl diisocyanate, and 1-ethyl-3-(3-dimethylaminopropyl) carbodiimide.

Other additives can be incorporated in the plastisol-coated agrochemicals, such as urease inhibitors, buffers, mineral oil, vegetable oil, fatty acids, anticaking agents, waxes, dispersants, diluents, fillers, desiccants, and polyurethanes. These additives can be added to the plastisol formulation or to the agrochemical substrate. The urease inhibitors can improve the stability of urea and prevent its volatilization. Several types of additives can improve the handling properties of the plastisol-coated agrochemical, such as anticaking agents, mineral oil, vegetable oil, wax, diluents, fillers, and desiccants. Certain additives such as drying oils (linseed oil, safflower oil, etc.), wax, mineral oil, or alkyd resins can further improve the delayed release properties of the plastisol-coated agrochemical. In embodiments, an agrochemical can be treated with a drying oil before or after coating with a plastisol.

### 2. Plastisol-Coated Agrochemicals

To form a plastisol-coated agrochemical, the coating ingredients that form the plastisol can be applied to a solid agrochemical as a pre-blended mixture, or the coating ingredients can be added sequentially, where the plastisol fusion occurs after the components are blended together with the agrochemical. In embodiments, the plastisol comprises a polymer resin such as PMMA, PVC, cellulose ester, cellulose ether, or combinations thereof. In embodiments, a one-pot coating method can be used, where all of the plastisol components are blended before introducing the agrochemical ingredient. The plastisol components in the blend can include plasticizers, PMMA resins, PVC, dispersants, diluents, crosslinkers, fillers, desiccants, and anti-caking agents.

In embodiments, agrochemicals can be coated with the plastisol. In an exemplary method, a polymer and a plasticizer are contacted with an agrochemical, the mixture is heated above the fusion temperature of the plastisol, and then the mixture is allowed to cool. In embodiments, the plastisol ingredients are pre-blended into a liquid slurry that is applied to the uncoated agrochemical. In other embodiments, the plastisol ingredients are sequentially added to the uncoated agrochemical. In certain embodiments, the agrochemical is coated with the plastisol at or near the point of agrochemical manufacture. In embodiments, the agrochemical is preheated due to manufacturing or processing conditions, such as urea manufacture, and the heat energy is used to assist in fusion of the plastisol coating. In embodiments, the agrochemical is coated with the plastisol at or near the point of end use. In embodiments, urea is coated with plastisol ingredients while the urea is still hot from the process of its manufacture. In an exemplary method, a polymer, plasticizer, and crosslinker are contacted with an agrochemical, and then the mixture is allowed to cure.

Agrochemicals that can be coated with plastisol include formulated nitrogen/phosphorus/potassium (N/P/K) fertilizers, urea, urea-ammonium nitrate (UAN), ammonium nitrate, potash, phosphates, monoammonium phosphate (MAP), diammonium phosphate (DAP), and the like. Other agrochemicals that can be coated with plastisol include solid materials that are used as pesticides, insecticides, herbicides, plant growth regulators, pheromones, fungicides, and the like.

### 3. Agricultural Treatments Using Plastisol-Coated Agrochemicals

Plastisol-coated agrochemical formulations as disclosed herein can offer controlled release benefits; for example, a single application of a plastisol-coated agrochemical can take the place of multiple applications of an uncoated agrochemical, providing a savings in labor and energy. Also, the plastisol-coated agrochemicals can reduce runoff from the initial spike of chemicals released when using uncoated agrochemicals. Furthermore, these controlled release properties reduce the risk of fertilizer “burn” from overuse of nutrients.

Plastisol-coated agrochemicals as disclosed herein offer other advantages. For example, there are no solvents, volatile organic compounds, or hazardous chemicals required to make a plastisol coating. Also, once the plastisol coating is cured it is pliable and not adhesive, so the plastisol coated agrochemical has favorable handling properties such as low dusting and low clumping.

Agricultural formulations, as described herein, comprising agricultural chemicals in solid form, can be used as fertilizers, herbicides, fungicides, insecticides, nutrients, and the like. Agricultural chemicals in solid form can be powders, granules, prills, and other particulate formulations. Examples include urea, atrazine, ammonium nitrate, ammonium sulfate nitrate, diammonium phosphate, potassium chloride, phosphate compounds, formulated N/P/K fertilizers, and the like.

In addition to the problems of run-off and chemical change or decomposition, the solid nature of certain agricultural chemical species presents challenges for handling and application. The plastisol formulations as disclosed herein can be used to coat particles of active ingredients so that they have improved flowability and controlled release properties. The disclosed formulations can also coat the particles with a thin, flexible coating that resists cracking and subsequent moisture egress. Furthermore, coated particles that use the disclosed formulations can result in less dust formation, improved handling, and ease of application.

Methods of using the plastisol-coated agrochemicals include broadcasting and spraying. The plastisol-coated agrochemicals can be applied wherever the agrochemical would be used for an agricultural treatment. For example, the plastisol-coated agrochemical can be applied to an agricultural target, e.g., a plant, a fruit, a vegetable, and the like, or the soil within which the plant, fruit, vegetable, etc. resides. As used herein, the term “agricultural treatment” refers to any chemical or biological active ingredient used to affect the longevity, productivity, or other biological or economic aspect (collectively, the “well-being”) of an agricultural target. Non-limiting examples of agricultural treatments include pesticides, herbicides, fungicides, plant growth regulators, plant hormones, probiotics, beneficial bacteria or beneficial fungi, biological control agents, and fertilizers. Agricultural treatments further comprise biological control agents, which exert a beneficial effect on an agricultural target through their biological activity, for example by competing with agricultural pathogens for space or nutrient on the agricultural target, or by antagonizing the growth of agricultural pathogens, by inducing resistance in the agricultural target, by acting as a natural enemy to an agricultural pest, or by other biologically-mediated processes. As used herein, an agricultural target can include plant surfaces (including foliage, stems, seeds, flowers, and roots), seed surfaces (pre- or post-harvest), and soil surfaces.

### Examples

### Materials

Acetyltributylcitrate (Sigma Aldrich)
Bentonite, Sigma Aldrich, St. Louis, Mo.
Cellulose acetate butyrate 551-0.01 (Eastman Chemical)
Cellulose acetate butyrate 551-0.2 (Eastman Chemical)
Cellulose acetate butyrate 553-0.4 (Eastman Chemical)
Cellulose Acetate Propionate 504-0.2 (Eastman Chemical)
Cellulose Triacetate CA436-805 (Eastman Chemical)
Cellulose Acetate Phthalate C-A-P (Eastman Chemical)
PMMA copolymer resins (Dianal LP-3202, LP-3207, LP-3109 (Mitsubishi Rayon))
Benzoate ester plasticizers (Benzoflex 181, LC531, 9-88 (Eastman Chemical))
Diisononyl cyclohexane-1,2-dicarboxylate (Hexamoll (BASF))
Urea, 46-0-0 fertilizer pellets (Sierra Chemical)
Mineral oil (Sigma Aldrich)
Other materials described in Examples below

### Example 1

### Nitrogen Release Measurement Protocol

Release of nitrogen from experimental samples of coated urea fertilizer (prepared in accordance with the Examples below) was measured by passing a measured amount of water over a sample of the fertilizer, where 30 mL of water is intended to be equivalent to 1 inch of rain. To make the experimental measurements, a 5.5 cm diameter VWR Grade 417 filter paper was placed in a Buchner funnel and a 3 gram sample of coated urea fertilizer was placed on top of the filter paper. The funnel was then placed on an Erlenmeyer flask connected to a vacuum pump. An amount of water from 30 mL to 4500 mL was measured out and poured over the coated fertilizer while the vacuum pump was running. The water was poured as a constant stream while keeping the coated fertilizer mostly or completely submerged. After all of the water was poured, the remaining coated fertilizer was transferred to pre-weighed aluminum pan and put in an oven at 100° C. to evaporate the moisture. After 30 minutes in the oven, the final mass of the remaining coated fertilizer was measured and compared to the starting mass to determine the amount of nitrogen that was released into the water. This test was repeated multiple times for each sample with varying amounts of water, in order to measure the nitrogen release behavior of different coated urea samples, with further details provided in the Examples below.

### Example 2

### Coated Urea Preparation

A lab scale batch of coated urea was prepared for testing as described above, in order to analyze how long it takes for all of the urea to be released from the coating and into water. A 100 gram sample of uncoated urea (46-0-0, 46% Nitrogen) was placed into a FlackTek container (501-221t- Max 100 Cup). The container was put onto a tared scale and 1.5 grams of Benzoflex 181 was measured directly into the container with the urea. The container was then placed in a FlackTek SpeedMixer (DAC 150 FVZ-K) and mixed at 1000 RPM for 30 seconds. After the mixing, 1.0 g of Dianal LP-3202 polymer powder was added directly into the container and it was mixed again at 1000 RPM for 30 seconds. Next the sample was cured uncovered in an oven at 120° C. for 75 minutes and then cooled to room temperature.

### Example 3

### Formulations with Mineral Oil

Samples of coated urea were prepared by the method of Example 2, but with an extra step of adding mineral oil. Sample 3a was prepared by adding 0.5 g mineral oil before the curing step. Sample 3b was prepared by adding 0.5 g mineral oil after the curing step. Samples 3a and 3b had less tendency to stick together compared to the sample of Example 2. The tendency to stick together is understood to produce coating flaws, handling problems, and storage problems. The samples 3a and 3b demonstrated less clumping in the finished product, and they also resisted water absorption better than the sample of Example 2. The results of sample 3a were somewhat better than the results of 3b, showing improved flowability and less clumping.

### Example 4

### Comparison of Polymer Samples

In this example, coated urea samples were prepared as described in Example 2, but the polymer powder was blended with Benzoflex 131 before adding the coating mixture to urea. Three polymer powders were compared, Dianal LP-3202, LP-3207, and LP-3109. The polymer LP-3202 took the longest to disperse in Benzoflex 131, initially forming clumps that required time and agitation to disperse; LP-3207 dispersed much more quickly than LP-3202 and did not form any clumps; LP-3109 dispersed more quickly than either of the others and did not form any clumps. A series of coated urea samples was prepared with different amounts of the coating formulation. The coated samples were cured at 120° C. for 25 minutes and then the samples were tested by the nitrogen release measurement protocol as described in Example 1. These results are detailed in Table 1 below.

TABLE 1

| | | 30″ rainfall test results | | 80″ rainfall test results | |
|---|---|---|---|---|---|
| Test | Coating | (% nitrogen released) | | (% nitrogen released) | |
| No. | weight (%) | LP-3207 | LP-3109 | LP-3207 | LP-3109 |
| 4.1 | 0.00 | 80.6% | 80.6% | 100% | 100% |
| 4.2 | 1.00 | 40.2% | 48.4% | 87.8% | 99.3% |
| 4.3 | 1.50 | 18.4% | 25.7% | 68.4% | 84.6% |
| 4.4 | 2.00 | 1.6% | 13.5% | 17.8% | 49.9% |
| 4.5 | 2.50 | 0.6% | 7.7% | 8.6% | 24.9% |

### Example 5

### Coating Urea with Different Cure Times

Urea samples were coated with a combination of LP-3207 polymer (at 1.0% based on urea) and three different plasticizers (at 1.5% based on urea). Total coating weight was 2.5%. The blended samples were cured at 120° C. for 25 minutes and 75 minutes for comparison. The urea samples coated with LP-3207 polymer plus plasticizers Benzoflex 131, Benzoflex 181, or acetyltributylcitrate (ATBC) were evaluated in this series, and the resulting samples of coated urea were tested by the nitrogen release measurement protocol as described in Example 1. The results of these tests are shown in Table 2 below.

TABLE 2

| | | Percent Nitrogen Released | |
|---|---|---|---|
| | | in 80″ rainfall test | |
| Test | | Cure time of | Cure time of |
| No. | Plasticizer | 25 minutes | 75 minutes |
| 5.1 | Benzoflex 131 | 11.41% | 33.41% |
| 5.2 | Benzoflex 181 | 30.40% | 46.86% |
| 5.3 | ATBC | 18.10% | 29.82% |

In these tests, urea samples coated with LP-3207 polymer plus Benzoflex 131 or LP-3207 polymer plus ATBC released less nitrogen during the nitrogen release measurement than samples coated with Benzoflex 181 at both cure times.

### Example 6

### Evaluation of Cure Times

In this example, samples of urea were coated with LP-3207 or LP 3209 polymers and Benzoflex 181, and cured at 120° C. for 25 and 75 minutes. The resulting samples of coated urea were evaluated with the nitrogen release measurement protocol of Example 1, and the results of these tests are shown in Table 3 below. The LP-3209 polymer with Benzoflex 181 did not outperform LP-3207 with Benzoflex 181 at 25 minutes of cure time.

TABLE 3

| | | | | Total | Cure | Nitrogen |
|---|---|---|---|---|---|---|
| Test | LP-3029 | LP-3027 | Benzoflex | coating | time | release |
| No. | (%) | (%) | 181 (%) | (%) | (min) | (%) |
| 6.1 | 1.00 | 0.00 | 1.50 | 2.50 | 25 | 47.78 |
| 6.2 | 1.00 | 0.00 | 1.50 | 2.50 | 75 | 37.54 |
| 6.3 | 0.00 | 1.00 | 1.50 | 2.50 | 25 | 30.40 |
| 6.4 | 0.00 | 1.00 | 1.50 | 2.50 | 75 | 46.86 |

### Example 7

### Evaluation of Polymer/Plasticizer Ratios

In this example, samples of urea were coated with 2.5% coatings at different ratios of polymer to Benzoflex 181. The resulting samples, after curing, were tested with the nitrogen release measurement protocol of Example 1 using 80″ of simulated rainfall (2400 mL water), and the results are presented in Table 4 below.

TABLE 4

| | | | Total | | |
|---|---|---|---|---|---|
| Test | LP-3207 | Benzoflex | coating | Cure | Nitrogen |
| No. | (%) | 181 (%) | (%) | conditions | release (%) |
| 7.1 | 0.63 | 1.87 | 2.50 | 120° C., 75 min | 59.2 |
| 7.2 | 0.83 | 1.67 | 2.50 | 120° C., 75 min | 30.9 |
| 7.3 | 1.00 | 1.50 | 2.50 | 120° C., 75 min | 46.9 |
| 7.4 | 1.25 | 1.25 | 2.50 | 120° C., 75 min | 59.6 |
| 7.5 | 1.67 | 0.83 | 2.50 | 120° C., 75 min | 42.4 |

### Example 8

### Coatings with Biodegradable Polymers

Samples of urea were coated with polymer and plasticizer blends as described in Example 2, but in this test some of the polymer was a biodegradable cellulose acetate butyrate (CAB). The blends were prepared as detailed in Table 5 below, and the coated urea samples were cured at 120° C. for 75 minutes. After curing the samples were evaluated by the nitrogen release measurement protocol of Example 1 and using 80″ (2400 mL) of simulated rainfall. The test demonstrates that a biodegradable polymer is satisfactory for use as a plastisol coating for a controlled release urea formulation.

TABLE 5

| | | | | | Total | Nitrogen |
|---|---|---|---|---|---|---|
| Test | LP-3207 | Benzoflex | CAB | CAB | coating | release |
| No. | (%) | 181 (%) | type | (%) | (%) | (%) |
| 8.1 | 1.00 | 1.50 | — | 0.00 | 2.50 | 46.9 |
| 8.2 | 0.50 | 1.50 | 551-0.01 | 0.50 | 2.50 | 64.9 |
| 8.3 | 0.50 | 1.50 | 551-0.2 | 0.50 | 2.50 | 45.0 |

### Example 9

### Comparison of Plasticizers

Samples of coated urea were prepared according the method of Example 2, but different plasticizers were substituted in the formulation, as set forth in Table 6. The coated samples were cured as shown in Table 6 below, and the resulting coated urea samples were tested by the nitrogen release measurement protocol of Example 1.

### Equivalents

While specific embodiments of the subject invention have been disclosed herein, the above specification is illustrative and not restrictive. While this invention has been particularly shown and described with references to preferred embodiments thereof, it will be understood by those skilled in the art that various changes in form and details may be made therein without departing from the scope of the invention encompassed by the appended claims. Many variations of the invention will become apparent to those of skilled art upon review of this specification. Unless otherwise indicated, all numbers expressing reaction conditions, quantities of ingredients, and so forth, as used in this specification and the claims are to be understood as being modified in all instances by the term “about.” Accordingly, unless indicated to the contrary, the numerical parameters set forth herein are approximations that can vary depending upon the desired properties sought to be obtained by the present invention.

What is claimed is:

1. A plastisol-coated agrochemical, comprising:
a coating formed from a plastisol formulation, wherein the plastisol formulation comprises a suspension of polymer particles in a liquid plasticizer,
and a solid agrochemical,
wherein the coating is applied to the solid agrochemical and cured to form a film thereupon.

2. The plastisol-coated agrochemical of claim 1, wherein the polymer particles are solid polymeric resin particles.

3. The plastisol-coated agrochemical of claim 2, wherein the solid polymeric resin particles are selected from the group consisting of PVC, PVC copolymers, PMMA, PMMA copolymers, cellulose ethers, and cellulose esters.

4. The plastisol-coated agrochemical of claim 2, wherein the solid polymeric resin particles comprise PMMA.

5. The plastisol-coated agrochemical of claim 2, wherein the solid polymeric resin particles are biodegradable.

6. The plastisol-coated agrochemical of claim 5, wherein the solid polymeric resin particles are selected from the group consisting of cellulose esters, cellulose ethers, ethylcellulose, methylcellulose, cellulose acetates, cellulose acetate butyrates, cellulose acetate propionates, cellulose acetate phthalates, cellulose triacetates, starch esters, and modified starches.

7. The plastisol-coated agrochemical of claim 2, further comprising a crosslinker.

8. The plastisol-coated agrochemical of claim 1, wherein the plasticizer is selected from the group consisting of benzoate esters, dibenzoate esters, terephthalate esters, cyclohexanedicarboxylate esters, citrate esters, phthalate esters, and cellulose esters.

9. The plastisol-coated agrochemical of claim 1, wherein the plasticizer is a monoester or diester of a dicarboxylic acid selected from the group consisting of malonates, succinates, glutarates, adipates, pimelates, sebacates, azelates, dibenzoates, citrates, trimellitates, cyclohexanoates, phthalates, and terephthalates.

10. The plastisol-coated agrochemical of claim 1, wherein the plasticizer is a polyester formed from diacid, and a diol or polyol.

11. The plastisol-coated agrochemical of claim 1, wherein the plasticizer is biodegradable.

12. The plastisol-coated agrochemical of claim 1, wherein the agrochemical comprises an active ingredient selected from the group consisting of nutrients, pesticides, insecticides, fungicides, herbicides, plant growth regulators, plant hormones, pheromones, and fertilizers.

13. The plastisol-coated agrochemical of claim 12, wherein the active ingredient is moderately water soluble or highly water soluble.

14. The plastisol-coated agrochemical of claim 12, wherein the fertilizer is selected from the group consisting of urea, ammonium nitrate and potassium chloride.

15. A method of affecting the well-being of an agricultural target, comprising:
providing a plastisol-coated agrochemical of claim 1, and
applying an effective amount of the plastisol-coated agrochemical upon the agricultural target, wherein the effective amount affects the well-being of the agricultural target.

16. The method of claim 15, wherein the plastisol-coated agrochemical comprises a coating comprising a PMMA polymer or a PMMA copolymer, and further comprises an agrochemical comprising urea.
